(19) United States
(12) Patent Application Publication
(10) Pub. No.: US 2023/0393031 A1
(43) Pub. Date: Dec. 7, 2023

(54) TRANSFER DEVICE FOR TRANFERRING A PLURALITY OF OBJECTS THROUGH A TRANSFER PORT

(71) Applicant: MERCK PATENT GMBH, Darmstadt (DE)

(72) Inventors: Stéphane OLIVIER, Molsheim (FR); Vincent SCHAAL, Molsheim (FR)

(73) Assignee: MERCK PATENT GMBH, Darmstadt (DE)

(21) Appl. No.: 18/033,195

(22) PCT Filed: Oct. 20, 2021
(86) PCT No.: PCT/EP2021/079015

§ 371 Date: Apr. 21, 2023

(30) Foreign Application Priority Data
Oct. 23, 2020 (EP) 20306269.0

(51) Int. Cl. G01N 1/22; G21F 7/005

(52) U.S. Cl. CPC G01N 1/2226; G21F 7/005; G01N 2001/1037

(57) ABSTRACT

The present application relates to a transfer device (60) for transferring a plurality of objects (O) through a transfer port (R), comprising a container (61) with an internal space (67) configured to accommodate the plurality of objects (O) to be transferred through the transfer port (R). The container (61) has at least one extraction opening (62) at an end portion of the container (61) in an axial direction (X) dimensioned such that the objects (O) can be removed from the container (61) at least individually, a door (63) configured to selectively close the at least one extraction opening (62) and seal the internal space (67) from the environment, and a piston (64) arranged in the container (61) so as to be movable in a translational motion in the axial direction (X) towards/away from the at least one extraction opening (62) to move the objects (O) accommodated in the container (61).

### TECHNICAL FIELD

The present application relates to a transfer device for transferring a plurality of objects through a transfer port into or from a clean processing area. The present application particularly concerns the field of testing in pharmaceutical and food processing and more particularly environmental monitoring of clean or ultra clean processing areas. It is also applicable to other processing situations where cleanness of a processing area or environment is to be determined and monitored, for example in the field of semiconductor, electronics or aircraft manufacturing.

### BACKGROUND

In order to monitor environmental conditions in closed processing areas of the above type it is common practice in passive air sampling to place one or more media plate/plates in an activity zone of the production area and expose them to the surrounding air such that they can capture the maximum amount of particles in the surrounding air. Larger particles tend to settle faster on the plates due to gravitational force. Smaller particles take some time in settling due to factors such as air currents. Media plates work best in still areas. The microorganisms from the air may settle on the media plates alone or in colonies.

In active monitoring of air in production areas a microbial air sampler is used to force air into or onto a collection medium over a specified period of time. The collection medium can be a common petri-dish, for example including a nutrient agar-based test media or other suitable test media depending on the need.

The collection media, for example in the form of the media plates, petri-dishes or settle plates (the terms will be used interchangeably in this specification), have to be transferred repeatedly into the production area and removed therefrom for further handling and evaluation. This is commonly done in a manual process where one or more plates or petri-dishes are conveyed manually through a sterile transfer port into and from the interior of the production area. However, the manual handling of the petri-dishes involves a high risk of contamination when handling the media plates, i.e. that lids may be inadvertently opened, displaced or removed from their media plates during handling involving introduction, installation and removal, thereby compromising the detection result, in particular when a plurality of them are handled in batches.

Sterile transfer ports for selective access through a valve to a clean processing area without compromising the sterility are known. Such systems are also known as “RIP” or “rapid transfer ports” and the present application is directed to a transfer device that is useful in conjunction with such a transfer port, i.e. is configured so as to be compatible with the respective valve design.

For example, GB 2237816 A1 discloses a double-door transfer port which allows a contained transfer between a container and an isolator, i.e. a clean processing area. The container is docked with its closed port and then, from within an isolator, the port door is opened. The docking of the container to the isolator may be accomplished using a bayonet system, in twisting the container around its axis to dock it into place at the port. Because the container must be physically rotated, the contents thereof are also subjected to rotation, which may spill liquids or damage delicate equipment. In this prior art, the whole of the lid and bayonet-closure mechanism of the container is housed in a short cube-or-collar-like extension of the container mounted on the container itself via a gas-tight slip-ring joint. With such an arrangement, the extension is rotated to dock the container into place onto the port, but because of the slip-ring joint, the container need not rotate. This device only presents the open container to be accessible from the inside of the isolator, thus making the handling of the objects difficult, in particular where the objects to be transferred are media plates, petri-dishes or settle plates for the reasons given above.

The present application considers application of the transfer principle of docking a container holding one or more objects to be transferred to a rapid transfer port of an isolator, opening the port and transferring the objects from the container into the isolator and vice versa.

The present application aims at providing a transfer device for transferring a plurality of objects, in particular petri-dishes as the objects to be transferred, through the transfer port in an active process without compromising the sterility.

### SUMMARY

To solve the problem, the present application provides a transfer device for transferring a plurality of objects through a transfer port, in particular petri-dishes, with the features of claim 1, as well as a process for transferring a plurality of objects through a transfer port with the features of claim 12. Preferred embodiments are defined in the dependent claims.

The present application specifically provides a transfer device for transferring a plurality of objects through a transfer port, comprising:
a container with an internal space configured to accommodate the plurality of objects to be transferred through the transfer port,
wherein the container has at least one extraction opening at an end portion of the container in an axial direction dimensioned such that the objects can be removed from the container at least individually,
a door configured to selectively close the at least one extraction opening and seal the internal space from the environment; and
a piston arranged in the container so as to be movable in a translational motion in the axial direction towards/away from the at least one extraction opening to move the objects accommodated in the container.

Preferably, the piston is configured to be actuated from an outside of the container.

Preferably, the container has an access opening for introducing a pushing and/or pulling force on the piston to effect the translational motion of the piston in the container.

Preferably, the internal space of the container is sealed from the outside environment of the container by means of a deformable sleeve and/or a sliding seal sealed (or located) between the piston and the container.

Preferably, the sleeve is at least partially elastic and/or foldable and/or rollable to follow the translational motion of the piston while maintaining the sealed condition with respect to the outside environment.

Preferably, the at least one extraction opening is arranged at an axial end of the container or at a periphery of the axial end portion of the container.

Preferably, the at least one extraction opening and the piston are arranged at opposite sides of the container in the axial direction.

Preferably, the door is configured to be connected to the transfer port, preferably a transfer port in an “alpha part door design”.

Preferably, the container is rigid or semi-rigid.

Preferably, the container is a cylindrical container with an inner structure configured to receive a stack of the objects, preferably in the form of a stack of Petri-dishes in an aligned parallel orientation, and permit the movement of the objects along the axial direction.

Preferably, the transfer device comprises a stack of a plurality of Petri-dishes as the plurality of objects received inside the container.

The present application also provides a process for transferring a plurality of objects through a transfer port into a sterile or at least clean processing area or isolator, the process comprising, preferably sequentially, the steps of
(a) providing a transfer device as defined herein, comprising a stack of a plurality of objects, said objects preferably being petri-dishes;
(b) attaching said transfer device to said transfer port;
(c) opening the transfer port, thereby opening up the internal space of the container to the sterile or at least clean processing area or isolator;
(d) moving the piston in a translational motion in the axial direction (X) towards the at least one extraction opening, thereby moving the stack of the plurality of objects comprised in the container towards the at least one extraction opening, i.e. towards (in the direction of) the sterile or at least clean processing area or isolator; and
(e) removing the topmost object from the stack.

Preferably the process further comprises the step of
(f) repeating steps (d) and (e) until all objects of the stack have been removed.

Preferably the process also comprises the steps of
(g) closing the transfer port; and
(h) detaching said transfer device from said transfer port.

### BRIEF DESCRIPTION OF THE DRAWINGS

In the following, various embodiments will be described by reference to the attached exemplary schematic drawings, in which:

FIG. 1 is an external view of the present transfer device before docking to a rapid transfer port.

FIG. 2 is a perspective cut-away view of the present transfer device.

FIG. 3 is a perspective cut-away view of the present transfer device in the state where it is docked to the transfer port with the transfer port closed.

FIG. 4 is a perspective cut-away view of the present transfer device docked to the transfer port with the transfer port open.

FIG. 5 is a schematic diagram showing the working principle of a transfer device according to one embodiment as defined herein.

FIG. 6 is a schematic diagram showing the working principle of a transfer device according to another embodiment as defined herein.

FIG. 7 is a perspective cut-away view of a transfer port according to a further embodiment docked to a rapid transfer port.

FIG. 8 is a schematic diagram showing the working principle of a transfer device according to a still further embodiment.

### DETAILED DESCRIPTION

For the purposes of the present application, terms such as “horizontal”, “vertical”, “perpendicular”, and similar terms are—if not already explicitly indicated—considered to be “essentially horizontal”, “essentially vertical”, “essentially perpendicular”, provided that this does not negatively affect functionality. Preferably, the term “essentially” is to denote a deviation of at most 10°, more preferably of at most 5°, even more preferably of at most 4° or 3°, still even more preferably of at most 2° or 1° from being horizontal, vertical, and perpendicular, respectively.

The present application concerns a transfer device 60 for transferring a plurality of objects O through a transfer port R into a sterile or at least clean processing area or isolator (e.g. a rapid transfer port as, for example, disclosed in the document GB 2237816 A1) without compromising the sterility or cleanness of the objects and of the processing area or isolator. The objects to be transferred are preferably petri-dishes, generally comprising a receptacle and a mating lid, which are arranged in a stack in an aligned parallel orientation, preferably with the lid(s) directed towards the transfer port R (or towards an extraction opening 62 as defined below), and which are to be transferred into and out from the sterile or at least clean processing area or isolator where the plates are used to detect contaminants in the air.

The transfer device 60 generally comprises a container or cartridge 61, preferably in a form of a cylinder, that is preferably rigid or semi-rigid and is in any case configured to accommodate the plurality of objects O to be transferred through the transfer port R in the aligned parallel orientation in a stack S in an internal space 67. The container 61 is designed to be releasably connected (i.e. docked) to the rapid transfer port R.

The container 61 has at least one extraction opening 62 at an end portion of the container 61 in an axial direction X of the container 61 dimensioned such that the objects O can be removed from the internal space 67 of the container 61 at least individually through the opening 62. A door 63 configured to selectively close the at least one extraction opening 62 is releasably attached to the end portion of the container to seal the internal space 67 at the extraction opening 62 with respect to the environment (as long as the container is not connected to the transfer port R) and with respect to the transfer port after it is connected but the port is not opened yet.

A piston 64 is arranged inside the internal space 67 of the container 61 so as to be movable in a translational motion in the axial direction X towards/away from the at least one extraction opening 62 to move the objects O accommodated in the container 61 towards and from the extraction opening 62.

The inner dimension of the internal space 67 of the container 61, i.e. the diameter if the internal space is in the form of a round-cylinder, is selected so as to accommodate the objects at issue, preferably the plurality of petri-dishes in a stack.

The piston 64 is configured to be activated from an outside of the container 61. To this end, the container 61 has an access opening 65 at an end of the container 61 opposite to the end with the extraction opening 62. The access opening 65 is configured to enable introducing a pushing and/or pulling force on the piston 64 to effect the translational motion of the piston 64 within and along the internal space of the container 61 in the axial direction X.

The pushing force on the piston brings the objects in the stack towards the extraction opening 62, thereby presenting the objects at or near the opening inside the clean processing area when the rapid transfer port is open to allow easy gripping one by one. The pushing force can be applied to the piston by means of a rod (not shown in the figures) integrated with the piston or by means of a rod selectively engageable with the piston, for example via the access opening 65.

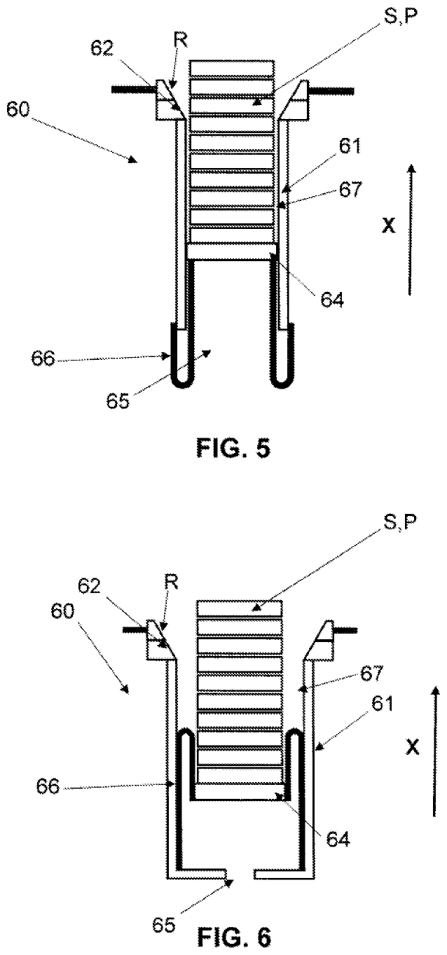

The internal space 67 of the container 61 for accommodating the objects is sealed from the outside environment of the container 61 by means of a deformable sleeve 66 sealed between the piston 64 and the container 61 (see FIGS. 5, 6 and 8). The sleeve 66 is preferably at least partially elastic and/or foldable and/or rollable to follow the translational motion of the piston 64 in the axial direction X while maintaining the sealed condition with respect to the outside environment and allowing the introduction of the force on the piston 64 through the access opening 65.

Although not shown in the figures the internal space 67 may be sealed from the outside environment of the container 61 by a sliding seal arranged between piston 64 and the inner surface of the container as an alternative to the deformable sleeve 66 or in combination with the deformable sleeve 66. This modification with the sliding seal is in particular applicable to the embodiment shown in FIG. 5.

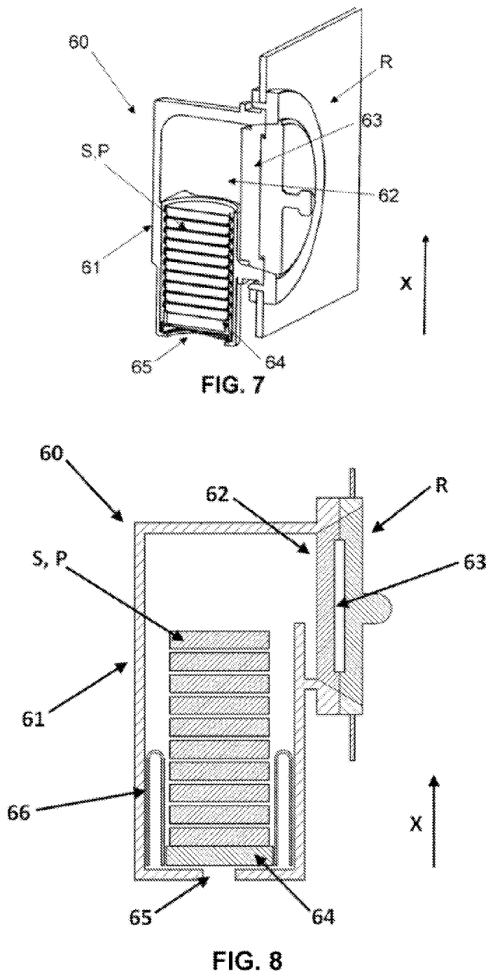

The sleeve 66 can be rolled either inside the container (see FIG. 6) or outside the container (see FIG. 5). In FIG. 7 the sleeve is not shown for clarity.

An external actuator acting on the piston 64 can be a cylinder operating a rod reaching through the access opening 65 at the end of the container 61. An embodiment where the extraction opening is arranged at the periphery of the container is shown in FIGS. 7 and 8. In this case access to the objects on the stack is made from the lateral or peripheral side of the container through the extraction opening 62.

The at least one extraction opening 62 is arranged at an axial end of the container 61 or at the periphery of the axial end portion of the container 61 at an opposite side from the access opening 65 so that the opening 62 and the piston 64 are preferably arranged at substantially opposite ends of the container in the axial direction. Plural extraction openings at different positions may be provided.

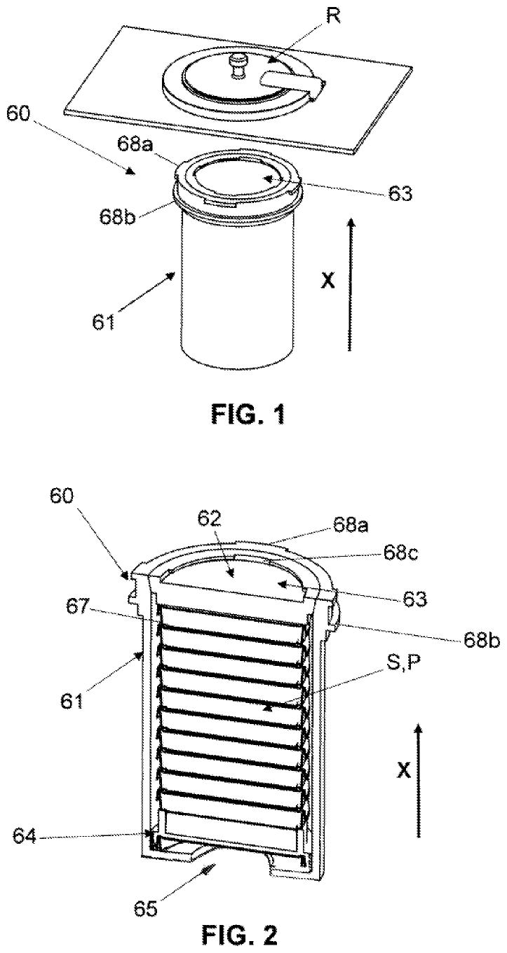

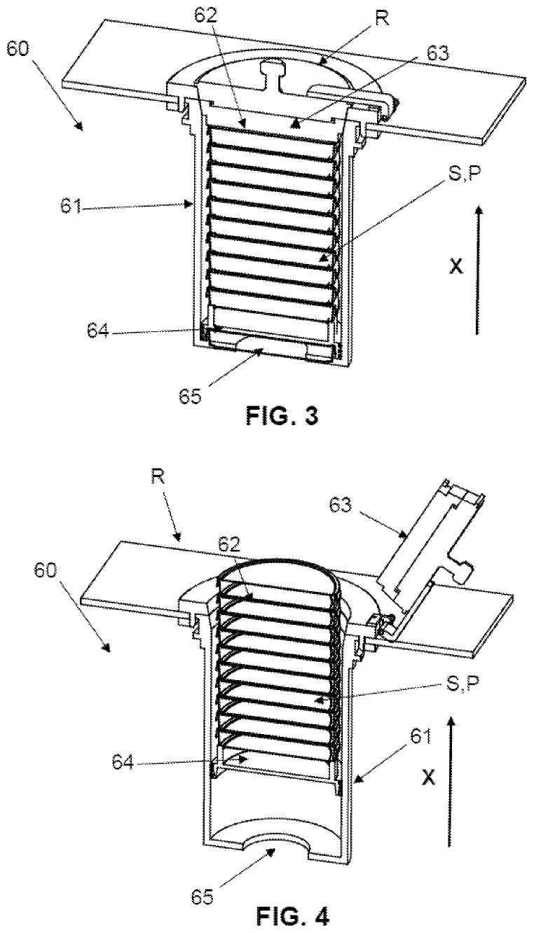

The container 61 and the door 63 are configured to be releasably connectable to a rapid transfer port R of the desired system to dock the container and the door to the isolator provided with the mating valve features. In the figures the docking structure is shown as an example and comprises bayonet-type engagement features 68a on the forward end of the cylinder and a stopper rim or edge 68b distanced from the engagement features 68a, and bayonet-type engagement features 68c on the front side of the door 63 as shown, for example, in FIGS. 1 and 2. The bayonet-type engagement features 68a and 68c of the cylinder and of the door are simultaneously engaged with the mating engagement features of the transfer port R when the device is docked to the transfer port R as shown in FIG. 3 and the door 63 may be simultaneously disengaged from the container. Then, the door 63 may be opened individually as shown in FIG. 3 without exposing any of the surfaces of the transfer device that have been exposed to the environment before to the internal spaces of the container and of the isolator. A useful system for the transfer port and thus for the door of the transfer device is the alpha part door design, as is known, for example, from LaCalhène (registered trademark) or other providers.

Depending on the size (diameter) of the container, the objects may not necessarily be aligned in the stack in the axial direction X of the container, but may be stacked in the direction transverse to the axial direction. In this case the entire stack is presented at the extraction opening at an end position of the translational motion in the axial direction and is then simultaneously accessible there for manual or automated handling and transfer devices from within the clean processing area (isolator). Handling from inside the clean processing area can be effected by a robot picking up the objects (petri-dishes) one by one or it can grip the entire stack.

The petri-dishes are given as a preferred example for the objects to be transferred by means of the transfer device, but the present application is not so limited and any objects that need be actively moved towards and through the extraction opening at the end portion of the container for presentation to automated handling equipment in a clean processing area are suitable to be used in conjunction with the transfer device defined herein.

Nevertheless, the present application concerns a unit comprising the transport device as defined herein including a stack S of a plurality of Petri-dishes P received inside the container prepared for use in processes of monitoring environmental conditions in closed processing areas.

The present application also relates to a process for transferring a plurality of objects through a transfer port R into a sterile or at least clean processing area or isolator, comprising the following steps (1) to (5) in sequence, wherein (1) a transfer device 60 as described herein comprising (preferably within container 61) a stack S of a plurality of objects O, said objects O preferably being petri-dishes P, is provided; (2) said transfer device 60 is then attached to said transfer port R; (3) subsequently, the transfer port R is opened, thereby opening the internal space 67 of the container 61 of the transfer device 60 to communicate with the sterile or at least clean processing area or isolator; (4) then, piston 64 is moved, preferably by applying a pushing force, in a translational motion in the axial direction (X) in the direction of, i.e. towards, the at least one extraction opening 62 (i.e. towards or in the direction of the sterile or at least clean processing area or isolator); and (5) in the following, the topmost object O (e.g. the object O closest to or inside the sterile or at least clean processing area or isolator), preferably a petri-dish P, is removed from the stack S and may be used as intended inside the sterile or at least clean processing area or isolator, for example, in monitoring environmental conditions, for example in air sampling.

It is noted that the petri-dishes P comprised in the transfer device 60, preferably comprised in container 61, are preferably oriented such that the lid of the petri-dishes faces or is directed towards extraction opening 62. Thus, step (1) of the present process preferably comprises the following steps of (1′) introducing a stack S of a plurality of petri-dishes P into transfer device 60, respectively container 61, with their lids facing towards extraction opening 62, and (1″) then providing such transfer device 60 comprising such stack S of petri-dishes P.

Above steps (4) to (5) may then be repeated until all objects O of the stack S have been removed from transfer device 60, respectively container 61.

Additionally, the present process may then further comprise the steps (6) of closing the transfer port R, and (7) detaching transfer device 60 as defined herein from said transfer port R. Transfer port R is then ready to receive a new fully charged, i.e. comprising a stack S of objects O, transfer device 60.

1. A transfer device (60) for transferring a plurality of objects (O) through a transfer port (R), comprising:
a container (61) with an internal space (67) configured to accommodate the plurality of objects (O) to be transferred through the transfer port (R),
wherein the container (61) has at least one extraction opening (62) at an end portion of the container (61) in an axial direction (X) dimensioned such that the objects (O) can be removed from the container (61) at least individually,
a door (63) configured to selectively close the at least one extraction opening (62) and seal the internal space (67) from the environment; and
a piston (64) arranged in the container (61) so as to be movable in a translational motion in the axial direction (X) towards/away from the at least one extraction opening (62) to move the objects (O) accommodated in the container (61).

2. The transfer device (60) according to claim 1, wherein the piston (64) is configured to be actuated from an outside of the container (61).

3. The transfer device (60) according to claim 2, wherein the container (61) has an access opening (65) for introducing a pushing and/or pulling force on the piston (64) to effect the translational motion of the piston (64) in the container (61).

4. The transfer device (60) according to claim 1, wherein the internal space (67) of the container (61) is sealed from the outside environment of the container (61) by means of a deformable sleeve (66) and/or a sliding seal sealed between the piston (64) and the container (61).

5. The transfer device (60) according to claim 4, wherein the sleeve (66) is at least partially elastic and/or foldable and/or rollable to follow the translational motion of the piston (64) while maintaining the sealed condition with respect to the outside environment.

6. The transfer device (60) according to claim 1, wherein the at least one extraction opening (62) is arranged at an axial end of the container (61) or at a periphery of the axial end portion of the container (61).

7. The transfer device (60) according to claim 1, wherein the at least one extraction opening (62) and the piston (64) are arranged at opposite sides of the container (61) in the axial direction (X).

8. The transfer device (60) according to claim 1, wherein the door (63) is configured to be connected to the transfer port (R), preferably a transfer port in an “alpha part door design”.

9. The transfer device (60) according to claim 1, wherein the container (61) is rigid.

10. The transfer device (60) according to claim 1, wherein the container (61) is a cylindrical container with an inner structure configured to receive a stack (S) of the objects (O), preferably in the form of a stack of Petri-dishes (P) in an aligned parallel orientation, and permit the movement of the objects (O) along the axial direction (X).

11. The transfer device (60) according to claim 10, further comprising a stack (S) of a plurality of Petri-dishes (P) as the plurality of objects (O) received inside the container.

12. A process for transferring a plurality of objects (O) through a transfer port (R) into a sterile or at least clean processing area or isolator, the process comprising, preferably sequentially, the steps of
(a) providing the transfer device (60) of claim 1, comprising a stack (S) of a plurality of objects (O);
(b) attaching said transfer device (60) to said transfer port (R);
(c) opening the transfer port (R), thereby opening up the internal space (67) of the container (61) to the sterile or at least clean processing area or isolator;
(d) moving the piston (64) in a translational motion in the axial direction (X) towards the at least one extraction opening (62), thereby moving the stack (S) of the plurality of objects (O) comprised in the container (61) towards the at least one extraction opening (62), i.e. towards (in the direction of) the sterile or at least clean processing area or isolator; and
(e) removing the topmost object (O) from the stack (S).

13. The process according to claim 12, the process further comprising the step of
(f) repeating steps (d) and (e) until all objects (O) of the stack (S) have been removed.

14. The process according to claim 12, further providing the steps of
(g) closing the transfer port (R); and
(h) detaching said transfer device (60) from said transfer port (R).
